(19) United States
(12) Patent Application Publication
(10) Pub. No.: US 2026/0291634 A1
(43) Pub. Date: Sep. 24, 2026

(54) METHOD AND MOBILE DEVICE

(71) Applicant: NEC CORPORATION, Tokyo (JP)

(72) Inventors: Pravjyot DEOGUN, Milton Keynes (GB); Xueicng WANG, Guildford (GB); Neeraj GUPTA, London (GB)

(73) Assignee: NEC CORPORATION, Tokyo (JP)

(21) Appl. No.: 19/472,761

(22) PCT Filed: Apr. 5, 2024
(86) PCT No.: PCT/JP2024/014048

§ 371 Date: Oct. 6, 2025

(30) Foreign Application Priority Data
Apr. 14, 2023 (GB) 2305560.1

(51) Int. Cl. H04B 17/391; H04W 8/22; H04W 24/10

(52) U.S. Cl. CPC H04B 17/3913; H04W 8/22; H04W 24/10

(57) ABSTRACT

In one described embodiment a method performed by a user equipment, UE, includes: receiving from a network node, a first indication for a model management decision and a second indication for model performance reporting; in a case where the first indication does not indicate activation of the model and the second indication enables model performance reporting, running the model and reporting model performance to the network node without using an output from the model to control communications with the network node. Various other methods are disclosed including corresponding network node methods

### TECHNICAL FIELD

The present disclosure relates to a communication system.

### BACKGROUND ART

The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive, relevance to artificial intelligence and machine learning (AI/ML) models used in ‘New Radio’ systems (also referred to as ‘Next Generation’ systems), and similar systems.

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node, base station, or access network node to refer to any such access nodes.

### CITATION LIST

### Non Patent Literature

NPL 1: The ‘NGMN 5G White Paper’ V1.0 by the Next Generation Mobile Networks (NGMN) Alliance, available from https://www.ngmn.org/5g-white-paper.html.

### SUMMARY OF INVENTION

### Technical Problem

Some of the additional developments in 3GPP relate to the use of artificial intelligence (AI) and machine learning (ML), often abbreviated to AI/ML.

Predictions or inferences generated using an AI/ML model can be used as part of various methods for improving the reliability or efficiency of communications in the network. For example, AI/ML models can be used to predict the path of a UE based on previous mobility of the UE, used for beam management, or used in methods of encoding and transmitting information. The supported use cases may include, for example: energy saving; traffic steering; anomaly detection; quality of experience (QoE) optimisation; mobility robustness optimisation (MRO); RAN slice service level agreement (SLA) assurance; massive multiple-input multiple-output (MIMO) beamforming optimisation; network slice subnet instance (NSSI) resource allocation; optimisation coverage and capacity optimisation (CCO); mobility load balancing (MLB); RACH optimisation; or UE transmission power optimisation.

An AI/ML model may be hosted at a base station, and the base station may perform control of communication resources or control related to the status of a UE (e.g. control of UE mobility, or control of a radio resource control, RRC, state of the UE) based on an inference (e.g. determination or prediction) generated using the AI/ML model. The base station may also transmit an inference generated using the model to another node in the network, for use at the other node. Alternatively, an AI/ML model may be hosted at two nodes of the network, for example at a base station and at a UE. In this case, the base station and the UE may both make determinations or predictions using the model. For example, the UE may use the model as part of an encoding process for encoding (and/or compressing) channel state information (CSI) for transmission to the base station, and the base station may use the same model as part of a corresponding decoding (and/or decompression) process for decoding the CSI received from the UE.

The inventors have been looking at ways to augment the air-interface with features that enable support for AI/ML based algorithms for enhanced performance (such as improved throughput, robustness, accuracy, reliability etc.) and/or reduced complexity/overhead. They have looked at using AI/ML based algorithms for CSI feedback enhancement (e.g., overhead reduction, improved accuracy and prediction); Beam management (e.g., beam prediction in time and/or spatial domain for overhead and latency reduction, beam selection accuracy improvement etc.); and positioning accuracy enhancements for different scenarios (including, e.g., those with heavy NLOS (Non-Line-Of-Sight) conditions).

More generally, there is a need for improved methods and apparatus for data collection for AI-ML model management and monitoring in the communication network.

### Solution to Problem

The disclosure aims to provide apparatus and methods that at least partially address at least one of the above needs and/or issues.

According to one aspect there is provided a method performed by a user equipment, UE, the method comprising: transmitting UE capability information to a network node; wherein the UE capability information indicates which reporting quantities or metrics the UE can support for model performance reporting.

According to another aspect there is provided a method performed by a user equipment, UE, the method comprising: receiving from a network node, a first indication for a model management decision and a second indication for model performance reporting; in a case where the first indication does not indicate activation of the model and the second indication enables model performance reporting, running the model and reporting model performance to the network node without using an output from the model to control communications with the network node.

According to another aspect there is provided a method performed by a user equipment, UE, the method comprising: receiving from a network node configuration data for model performance reporting in respect of plural model functionalities; running a model for each functionality configured by the configuration data; and reporting model performance for each model functionality in accordance with the configuration data.

According to another aspect there is provided a method performed by a user equipment, UE, the method comprising: running, at a first time, a model that predicts a parameter relating to a communication with a network node; obtaining at least one measurement of at least one signal that relates to the parameter that is predicted by the model and that is received by the user equipment around the first time; and reporting the parameter predicted by the model and the at least one measurement to the network node.

According to another aspect there is provided a method performed by a user equipment, UE, the method comprising: running a model that predicts a parameter relating to a communication with a network node; monitoring at least one metric related to the model or to the communication with the network node; and reporting to the network node in a case where the at least one metric meets at least one criterion.

According to another aspect there is provided a method performed by a network node, the method comprising: receiving from a user equipment, UE, UE capability information; wherein the UE capability information indicates which reporting quantities or metrics the UE can support for model performance reporting.

According to another aspect there is provided a method performed by a network node, the method comprising: transmitting to a user equipment, UE, a first indication for a model management decision and a second indication for model performance reporting; in a case where the first indication does not indicate activation of the model and the second indication enables model performance reporting, receiving a report from the UE of model performance in respect of a model that is run on the UE without using an output from the model to control communications with the network node.

According to another aspect there is provided a method performed by a network node, the method comprising: transmitting to a user equipment, UE, configuration data for model performance reporting in respect of plural model functionalities; and receiving model performance data from the UE in respect of running a model for each functionality configured by the configuration data for each model functionality in accordance with the configuration data.

According to another aspect there is provided a method performed by a network node, the method comprising: configuring a user equipment, UE, to run, at a first time, a model that predicts a parameter relating to a communication between the UE and the network node; wherein the UE obtains at least one measurement of at least one signal that relates to the parameter that is predicted by the model and that is received by the user equipment around the first time; and receiving a report from the UE including the parameter predicted by the model and the at least one measurement.

According to another aspect there is provided a method performed by a network node, the method comprising: configuring a user equipment, UE, to run a model that predicts a parameter relating to a communication with the network node; wherein the UE monitors at least one metric related to the model or to the communication with the network node; and receiving a report from the UE in a case where the at least one metric meets at least one criterion.

According to another aspect there is provided a user equipment, UE, comprising: means for transmitting UE capability information to a network node; wherein the UE capability information indicates which reporting quantities or metrics the UE can support for model performance reporting.

According to another aspect there is provided a user equipment, UE, comprising: means for receiving from a network node, a first indication for a model management decision and a second indication for model performance reporting; and means for running the model and reporting model performance to the network node without using an output from the model to control communications with the network node, in a case where the first indication does not indicate activation of the model and the second indication enables model performance reporting.

According to another aspect there is provided a user equipment, UE, comprising: means for receiving from a network node configuration data for model performance reporting in respect of plural model functionalities; means for running a model for each functionality configured by the configuration data; and means for reporting model performance for each model functionality in accordance with the configuration data.

According to another aspect there is provided a user equipment, UE, comprising: means for running, at a first time, a model that predicts a parameter relating to a communication with a network node; means for obtaining at least one measurement of at least one signal that relates to the parameter that is predicted by the model and that is received by the user equipment around the first time; and means for reporting the parameter predicted by the model and the at least one measurement to the network node.

According to another aspect there is provided a user equipment, UE, comprising: means for running a model that predicts a parameter relating to a communication with a network node; means for monitoring at least one metric related to the model or to the communication with the network node; and means for reporting to the network node in a case where the at least one metric meets at least one criterion.

According to another aspect there is provided a network node comprising: means for receiving from a user equipment, UE, UE capability information; wherein the UE capability information indicates which reporting quantities or metrics the UE can support for model performance reporting.

According to another aspect there is provided a network node comprising: means for transmitting to a user equipment, UE, a first indication for a model management decision and a second indication for model performance reporting; means for receiving a report from the UE of model performance in respect of a model that is run on the UE without using an output from the model to control communications with the network node, in a case where the first indication does not indicate activation of the model and the second indication enables model performance reporting.

According to another aspect there is provided a network node comprising: means for transmitting to a user equipment, UE, configuration data for model performance reporting in respect of plural model functionalities; and means for receiving model performance data from the UE in respect of running a model for each functionality configured by the configuration data for each model functionality in accordance with the configuration data.

According to another aspect there is provided a network node comprising: means for configuring a user equipment, UE, to run, at a first time, a model that predicts a parameter relating to a communication between the UE and the network node; wherein the UE obtains at least one measurement of at least one signal that relates to the parameter that is predicted by the model and that is received by the user equipment around the first time; and means for receiving a report from the UE including the parameter predicted by the model and the at least one measurement.

According to another aspect there is provided a network node comprising: means for configuring a user equipment, UE, to run a model that predicts a parameter relating to a communication with the network node; wherein the UE monitors at least one metric related to the model or to the communication with the network node; and means for receiving a report from the UE in a case where the at least one metric meets at least one criterion.

The various functional means defined above that are part of the UE may be provided by a memory and one or more processors that execute instructions stored in the memory. Similarly, the various functional means defined above that are part of the network node may be provided by a memory and one or more processors that execute instructions stored in the memory.

The disclosure may also provide a computer program product comprising computer implementable instructions for causing a programmable computer to carry out the method of any of the aspects described above. The computer implementable instructions may be provided as a signal or on a tangible computer readable medium.

### BRIEF DESCRIPTION OF DRAWINGS

Example embodiments of the disclosure will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 illustrates a resource grid of a sub-frame illustrated in FIG. 2;

FIG. 4 illustrates a mobility procedure performed when a UE moves from a source base station (or cell) to a target base station (or cell);

FIG. 5 illustrates a functional framework in respect of an AI/ML model;

FIG. 6 illustrates a method of training an AI/ML model, and of monitoring the performance of the AI/ML model;

FIG. 7 illustrates the way in which a base station may configure a UE for AI/ML performance reporting and different reporting options;

FIG. 8 illustrates the way in which a base station may configure a UE for taking AI/ML management decisions and different reporting options;

FIG. 9 is a schematic block diagram illustrating the main components of a UE for the telecommunication system of FIG. 1; and

FIG. 10 is a schematic block diagram illustrating the main components of a base station for the telecommunication system of FIG. 1.

### DESCRIPTION OF EMBODIMENTS

### Overview

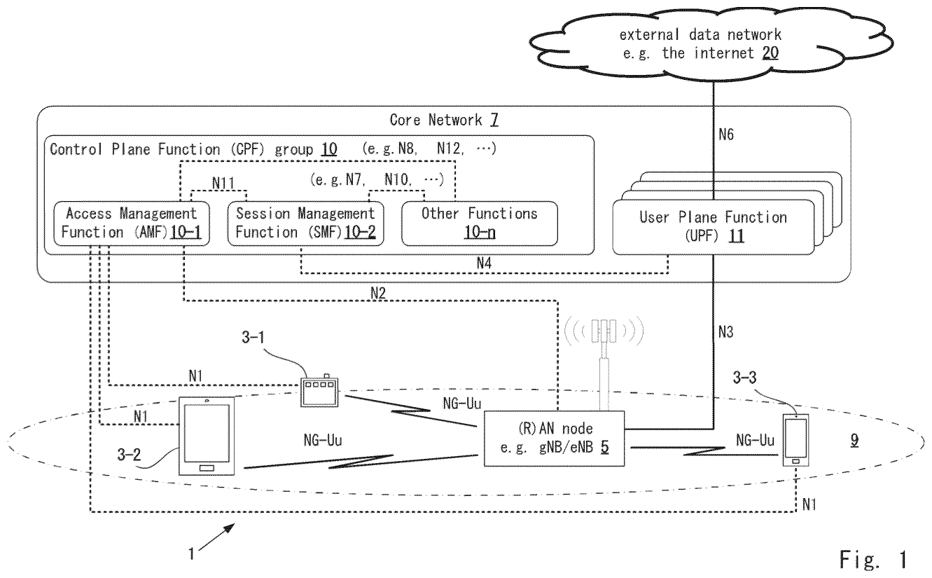

An exemplary telecommunication system will now be described in general terms, by way of example only, with reference to FIGS. 1, 2 and 3.

FIG. 1 schematically illustrates a mobile (‘cellular’ or ‘wireless’) communication system 1 to which example embodiments of the present disclosure are applicable.

In the communication system 1, user equipment (UEs) 3-1, 3-2, 3-3 (e.g. mobile telephones and/or other mobile devices) can communicate with each other via a radio access network (RAN) node 5 that operates according to one or more compatible radio access technologies (RATs). In the illustrated example, the (R)AN node 5 comprises a base station 5 or ‘gNB’ 5 operating one or more associated cells 9. Communication via the base station 5 is typically routed through a core network 7 (e.g. a 5G core network or evolved packet core network (EPC)).

As those skilled in the art will appreciate, whilst three UEs 3 and one base station 5 are shown in FIG. 1 for illustration purposes, the system, when implemented, will typically include other base stations 5 and UEs 3.

Each base station 5 controls one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) 10-2 and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

One or more UPFs 11 are connected to an external data network (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection. The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicity ServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-PositionsInBurst).

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

When the UE 3 initially establishes a radio resource control (RRC) connection with a base station 5 via a cell 9 it registers with an appropriate core network node (e.g., AMF, MME). The UE 3 is in the so-called RRC connected state and an associated UE context is maintained by the network. When the UE 3 is in the so-called RRC idle state, or is in the RRC inactive state, it selects an appropriate cell for camping so that the network is aware of the approximate location of the UE 3 (although not necessarily on a cell level).

The base station 5 may be a base station 5 that is split between one or more distributed units (DUs) 50 and a central unit (CU) 60, with a CU 60 typically performing higher level functions and communication with the next generation core, and with the DU 50 performing lower level functions and communication over an air interface with UEs 3 in the vicinity (i.e. in a cell operated by the base station 5). This type of base station 5 may be referred to as a ‘distributed’ base station 5 or gNB 5. A distributed gNB 5 includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the control-plane and user-plane entities may each include an associated transceiver circuit, antenna, network interface, controller, memory, operating system, and communications control module. When the base station 5 comprises a distributed base station, the network interface also includes an E1 interface and an F1 interface (F1-C for the control plane and F1-U for the user plane) to communicate signals between respective functions of the distributed base station.

### Frame Structure

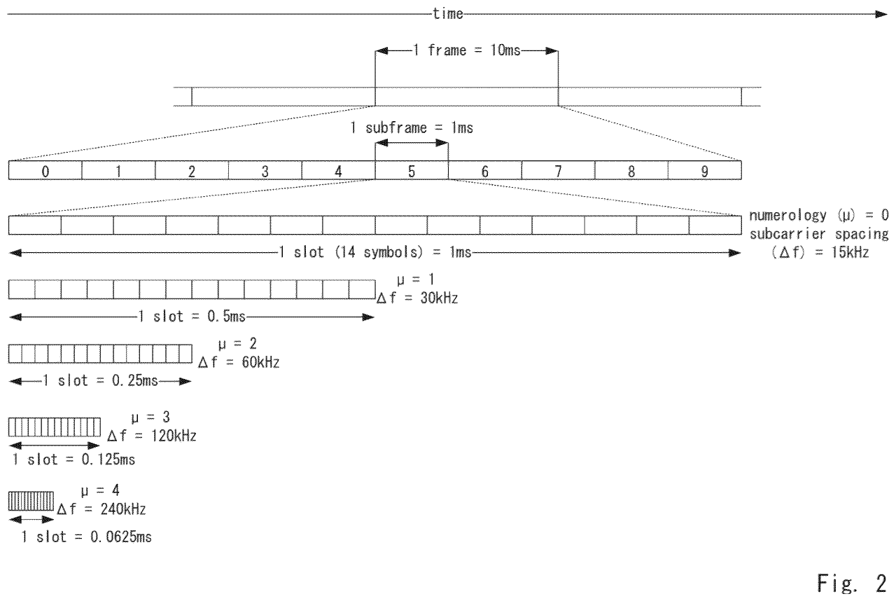

Referring to FIG. 2, which illustrates a typical frame structure that may be used in the communication system 1, the base station 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2^{μ} kHz). The relationship between the parameter, μ, and SCS (Δf) is as shown in Table 1:

TABLE 1
5G Numerology

| | | Number of slots | Slot length |
|---|---|---|---|
| μ | Δf = 2^{μ} · 15[kHz | per subframe | (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

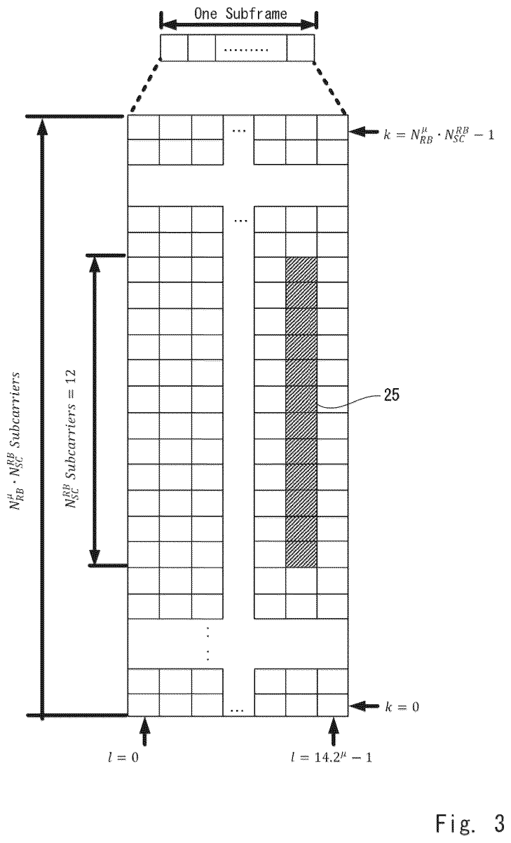

FIG. 3 illustrates the resource grid of a subframe shown in FIG. 2. As shown, the subcarrier spacing, the number of OFDM symbols within a subframe varies depending on the numerology. A single block shown in FIG. 3 corresponds to a single Resource Element and this is the smallest unit of the resource grid and is made up of one subcarrier in the frequency domain and one OFDM symbol in the time domain. A Resource Block 25 is defined only for the frequency domain and is defined as twelve consecutive subcarriers in the frequency domain in one OFDM symbol.

### System Information and SIB

It will be appreciated that transmissions in a cell 9 of a base station 5 may include one or more broadcast transmissions, one or more unicast transmissions for reception by a UE 3, and/or one or more multicast transmissions for reception by a group of UEs 3. System information (SI) transmitted in a cell may include ‘minimum SI’ (MSI) and ‘other SI’ (OSI). The OSI may be broadcast on-demand, for example using a downlink shared channel (DL-SCH). The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection, may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB).

The MSI comprises the MIB and system information block 1 (SIB1). The MIB includes information for use by the UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions (e.g. another dedicated RRC message). The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP TS 38.331. SIB2 provides information for intra-frequency, inter-frequency and inter-system cell reselection. SIB3 provides cell-specific information for intra-frequency cell reselection. SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIB1 may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using message 1 (MSG1), which may be referred to as a MSG1-based on-demand SI request, or message 3 (MSG3), which may be referred to as a MSG3-based on-demand SI request.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block comprises 240 contiguous subcarriers. When the UE 3 is in an RRC connected state, the base station 5 may provide the UE 3 with an indication of resources used for the SS/PBCH, for example using dedicated signalling. SIB1 may be transmitted using a physical downlink shared channel (PDSCH). The OSI may be similarly transmitted, for example, using a PDSCH. When one or more beamformed transmissions are transmitted in a cell provided by the base station 5, some of the SI (e.g. some of the SIB) may only be transmitted using particular beams, or using a particular transmission/reception point (TRP).

### UE Mobility

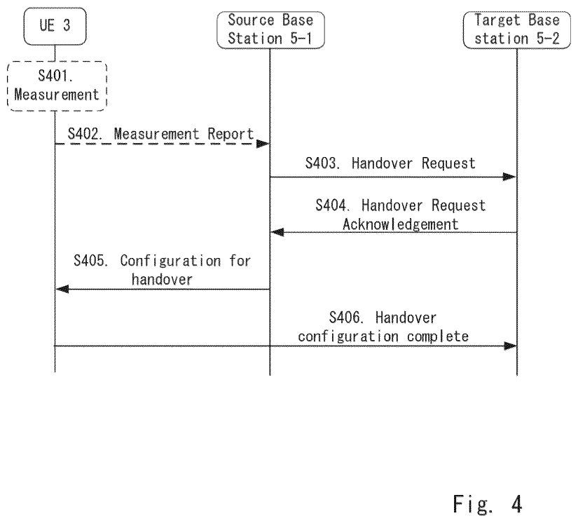

FIG. 4 shows an overview of a mobility procedure that may be performed in a communication system 1 of the type illustrated in FIG. 1. In this example, a handover of a UE 3 from a source base station 5-1 to a target base station 5-2 is performed.

In optional step S401 the UE 3 performs a measurement. The measurement may be a measurement of a signal transmitted by the source base station 5-1 or a measurement of a signal transmitted by the target base station 5-2. The measurement may be a measurement of a signal strength, that can be used as part of a determination that the UE 3 is to be handed over from the source base station 5-1 to the target base station 5-2. In optional step S402 the UE 3 transmits a measurement report to the source base station 5-1 that provides an indication of the result of the measurement. The measurement report may be transmitted from the UE 3 to the source base station 5-1 in an RRC message. In this example the source base station 5-1 uses the information provided in the measurement report to determine that the UE 3 is to be handed over to the target base station 5-2. However, it will be appreciated that a determination that handover to the target base station 5-2 is to be performed may alternatively (or additionally) be based on a measurement performed at the source base station 5-1 or at the target base station 5-2. Alternatively, a determination that handover of the UE 3 is to be performed may be based on a factor other than a signal measurement, such as a level of congestion in a cell operated by the source base station 5-1, or an inference (e.g. determination or prediction) generated using an AI/ML model.

In Step S403 the source base station 5-1 transmits a handover request to the target base station 5-2, requesting handover of the UE 3 from the source base station 5-1 to the target base station 5-2. The handover request may include an indication of, for example, an identity of the source base station 5-1, a cause value for the handover, an identity of the target cell, UE 3 context information (e.g. a maximum bit rate of the UE 3, or security capabilities of the UE 3), and UE history information. If the handover has been triggered by the measurement report received by the source base station 5-1 in step S402, then the cause value may indicate, for example, that the handover is desirable for radio reasons. Alternatively, if the handover has been triggered to reduce the load at the source base station 5-1, the cause value may indicate that the handover is for reducing load in the serving cell. The handover request message may also include an indication of the AMF 10-1 that is serving the UE 3.

In step S404, the target base station 5-2 transmits an acknowledgement of the handover request (which may be referred to as a “handover request acknowledgement” message). The handover request acknowledgement message includes an indication of handover configuration information for the handover that is to be forwarded to the UE 3. The handover request acknowledgement message may also include configuration information that enables the source base station 5-1 to begin forwarding user plane data for the UE 3 to the target base station 5-2.

The transmissions of steps S403 and S404 may be performed over an Xn interface between the source base station 5-1 and the target base station 5-2 (and therefore the handover procedure in this example may be referred to as an Xn-based handover procedure). Steps S401 to S404 may be referred to as a ‘handover preparation phase’.

In step S405, the source (R)AN node transmits the handover configuration information to the UE 3. The configuration information for the handover may be, for example, an RRC configuration transmitted in an RRC configuration message or an RRC reconfiguration message. In step S406, the UE 3 applies the received configuration for handover and transmits an indication to the target base station 5-2 that configuration for the handover is complete. The message transmitted in step S405 may be, for example, an RRC Reconfiguration Complete message. Steps S405 and S406 may be referred to as a ‘handover execution phase’.

Following the handover execution phase, the UE 3 is operable to transmit uplink transmissions to the target base station 5-2 (e.g. uplink data) and receive downlink transmissions from the target base station 5-2 (e.g. downlink data).

It will be appreciated that mobility methods and handover procedures for the UE 3 are not restricted to the example illustrated in FIG. 4. For example, the UE 3 may be configured to perform a conditional handover (CHO) in which the UE 3 determines whether handover of the UE 3 to a candidate cell is to be performed based on one or more execution conditions.

### Artificial Intelligence (AI)/Machine Learning (ML)

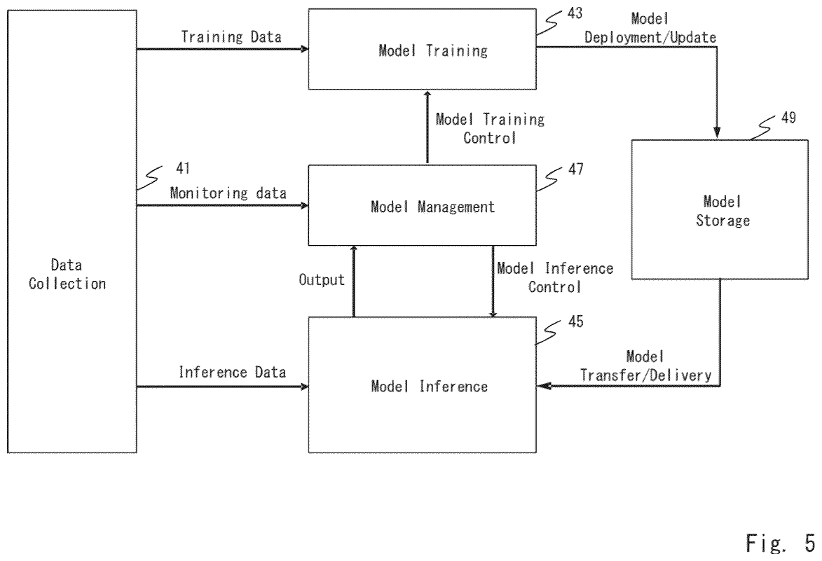

FIG. 5 illustrates a framework in respect of an AI/ML model, and how various entities of the framework may interact with one another.

The entities include a data collection function 41, a model training function 43, a model inference function 45, a model management function 47 and a model storage function 49. The data collection function 41 provides input data (training data) to the model training function 43 and the model inference function 45 as well as monitoring data to the model management function 47. The collected data may be, for example, data regarding mobility (e.g. handover of a UE 3, or a location of the UE 3). For example, the data may be obtained by a base station 5 (e.g. by receiving a measurement report from a UE 3, or by receiving data from another base station 5 or a core network node/function) and transmitted to another base station 5 that generates the AI/ML model inference output (or alternatively, the same base station 5 that obtains the data may generate the AI/ML model output).

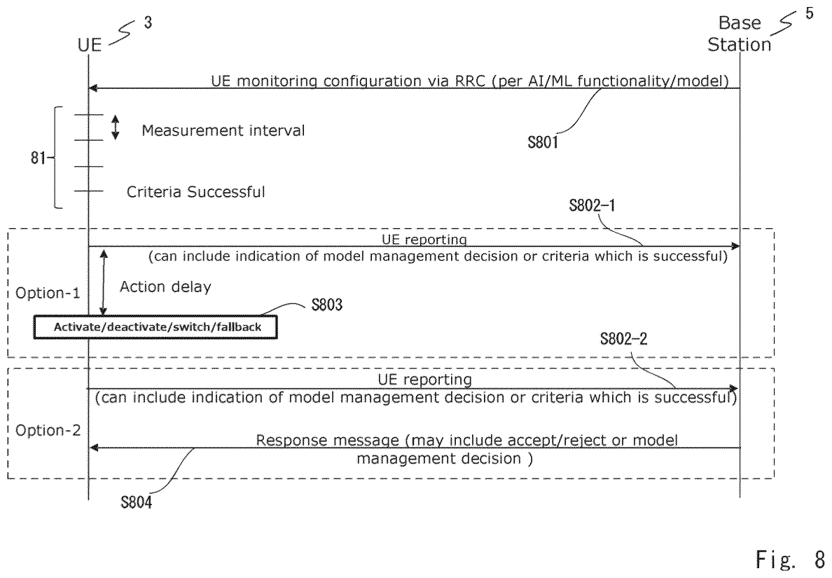

The model training function 43 performs the ML model training, validation, and testing, and may generate model performance metrics as part of a model testing procedure. The model inference function 45 provides AI/ML model inference output (e.g., predictions or decisions). The output from the model inference function 45 triggers the node running the model inference (which may be, for example, a base station 5 or a UE 3) to perform a corresponding action. The AI/ML model inference output may be, for example, a prediction of mobility (e.g. expected path, route or trajectory, inter-cell or inter-beam mobility, or expected handover) of the UE 3, or one or more parameters for use in encoding or decoding transmissions between the base station 5 and the UE 3. The model management function 47 is a function or node that manages the AI/ML models used in the network. The management functions performed by the model management function 47 include: monitoring the inference performance of an AI/ML model; enabling/disabling an AI/ML model for a specific function; selecting an AI/ML model for a specific function (where multiple models for that function are available); switching from a current AI/ML model to a different AI/ML model; and falling back to a previous AI/ML model for a specific function. The model storage function 49 maintains a record of the AI/ML models that are available and a record of those that are deployed (in use) within the network. The functions illustrated in FIG. 8 may be co-located at a single node of the communications network (e.g. at a base station 5 or core network node/function), or may be distributed amongst a plurality of network nodes (e.g. a plurality of base stations 5) or UEs 3.

Terms referred to by 3GPP in the context of this framework include:

AI/ML model Training: An online or offline process for training an AI/ML model.

AI/ML model Validation: A method for evaluating the quality (e.g. prediction accuracy) of an AI/ML model using a dataset that is different from the one used for the training of the model, and that can help to selecting model parameters that generalise beyond the dataset used for training.

AI/ML Model Testing: A method for evaluating the performance of a final AI/ML model, using a dataset different from the ones used for model training and validation. Unlike model validation, model testing does not assume subsequent tuning of the model.

AI/ML model Inference: A method of using a trained AI/ML model to produce a set of outputs based on a set of inputs.

AI/ML Data Collection: A method of collecting data by network nodes, management entity, and/or a UE 3, for training the AI/ML model, for data analytics (e.g. model performance monitoring), and/or for generating an inference using the trained AI/ML model.

Model Monitoring: A method of monitoring the inference performance (e.g. prediction accuracy) of the AI/ML model.

Model Activation: enable an AI/ML model for a specific function.

Model Deactivation: disable an AI/ML model for a specific function.

Model Switching: deactivating a currently active AI/ML model and activating a different AI/ML model for a specific function.

Training Data: Data for input to the AI/ML Model Training function.

Supervised Learning: A method of training an AI/ML model using labelled data.

Unsupervised Leaning: A method of training an AI/ML model using unlabelled data.

Semi-supervised Learning: A method of training an AI/ML model using both labelled and unlabelled data.

Reinforcement Learning: A method of training an AI/ML model using input and feedback resulting from the model's output in an environment the model is interacting with.

Inference Data: Data for input to the AI/ML Model Inference function, for generating an inference.

Model Deployment/Update: A method of deploying (e.g. transmitting to a network node) an AI/ML model to the Model Inference function, or of delivering an updated model to the Model Inference function.

The data collection 41 may be performed at various nodes of the communication network (e.g. at one or more base stations 5 or UEs 3).

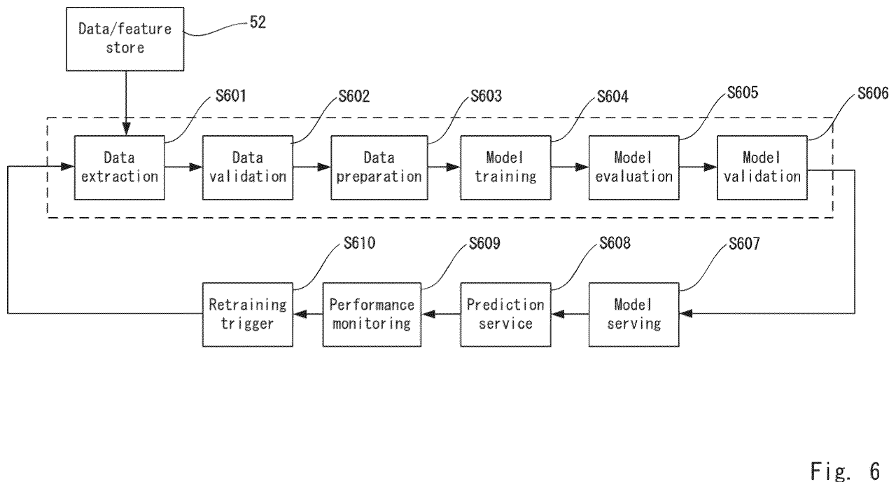

FIG. 6 shows an illustration of a method of training an AI/ML model, and of monitoring the performance of the AI/ML model. As illustrated in FIG. 6, stored data/features 52 may first be extracted in a data extraction step, S601. In the data validation step, S602, a determination of whether to proceed with training or retaining the AI/ML model is made (e.g. based on the extracted data). In the data preparation stage, S603, the data is prepared for use in training the AI/ML model. For example, the data may be cleaned (e.g. filtered), subject to a transformation, or modified in any other suitable manner. The data may also be divided into training data, validation data and test data sets in the data preparation stage.

In the model training step, S604, the AI/ML model is trained (or retrained) using training data prepared in the data preparation step S603. It will be appreciated that any suitable training method can be used to train the AI/ML model (e.g. a method that comprises supervised learning or unsupervised learning or reinforcement learning). In the model evaluation step, S605, the AI/ML model is evaluated (e.g. a prediction accuracy of the AI/ML model is evaluated) using a test data set (which may be generated in the data preparation step S603). In the model validation step, S606, a determination of whether the AI/ML model is suitable for deployment in the communication network is made (e.g. based on the results of the model evaluation step S605).

In the model serving step, S607, the AI/ML model is deployed for use in the communication system 1. AI/ML model deployment may comprise compiling a trained AI/ML model, packaging the model into an executable format, and delivering the AI/ML model to a target device. For example, the AI/ML model may be transmitted to the base station 5 and/or the UE 3, for use at the base station and/or the UE to generate predictions or determinations using the AI/ML model as part of a prediction service step, S608, as illustrated in FIG. 6. In the performance monitoring step, S609, the performance of the deployed AI/ML model is monitored. The predictive performance of the AI/ML model may be monitored by comparing predictions generated using the model with one or more measurements. For example, when the AI/ML model is used to predict a location of a UE 3, the prediction accuracy of the AI/ML model may be assessed using a measurement of an actual location of the UE 3. Alternatively, if the AI/ML model is used for determining parameters for use in encoding and decoding data transmitted between a base station 5 and a UE 3, the model may be assessed based on the performance of the encoding and/or decoding processes. In the retraining trigger step, S610, retraining of the AI/ML model is triggered (e.g. because the prediction accuracy of the AI/ML model has fallen below an acceptable threshold accuracy, or because a performance of a method that uses inferences from the AI/ML model has fallen below an acceptable threshold performance), and the method returns to the data extraction step S601.

### Single-Sided and Two-Sided Models

An AI/ML model may be hosted at both a base station 5 and a UE 3, may be hosted at only the base station 5, or may be hosted at only the UE 3. When the AI/ML model is used at the UE 3 only or at the base station only, the AI/ML model may be referred to as a ‘single-sided’ model. For example, the UE 3 may host an AI/ML model for generating a time (e.g. time resource) for communication using a particular beam transmitted by the base station 5. However, even when the model is a single-sided model, it will be appreciated that the model need not necessarily be trained at the UE 3. For example, the model could be trained at the base station 5 or at another node in the network (e.g. core network node/function), and then transmitted to the UE 3 for use at the UE 3. In other words, the AI/ML model may be trained at another network node, and then transferred/deployed to the UE 3.

Alternatively, the AI/ML model may be a ‘two-sided’ model, in which an AI/ML model is hosted at the UE 3 and a corresponding AI/ML model is hosted at the base station 5. The AI/ML model hosted at the UE 3 and the AI/ML model hosted at the base station 5 may be the same AI/ML model. The UE 3 can use the AI/ML model to generate a first inference, and the base station 5 can use the AI/ML model to generate a corresponding second inference. For example, the first inference may be an inference of a parameter to use for compressing data (e.g. channel state information (CSI)) to be transmitted from the UE 3 to the base station 5, and the second inference may be an inference of a parameter to use to decompress the data at the base station 5. As with the single-sided model case, the two-sided model (or models) may be trained at any suitable network node, and then transmitted to the UE 3 and the base station 5.

### Model Monitoring

As discussed above, model monitoring may be performed by the UE 3 or by a network node such as the base station 5. In the case of UE monitoring, the UE 3 performs the majority of the model monitoring, and it indicates limited information about model monitoring performance to the network (e.g., the base station 5) so that network (e.g., the base station 5) can take model management decisions. It is also possible that the UE 3 makes the model management decision autonomously and just informs the network (e.g., the base station 5) about the decision that the UE 3 has taken so that the network (e.g., the base station 5) can perform necessary UE reconfiguration for radio operation. For example, if the UE decides to deactivate the AI/ML beam prediction model, then the network (e.g., the base station 5) may need to configure the transmission of additional Reference Signals (RS) so that the UE 3 can still perform legacy beam measurements.

### Network Model Monitoring

In the case of network-based monitoring, the UEs 3 will report detailed information (e.g., actual measurements, model predictions, etc.) to the network (e.g., the base station 5) and the network then takes appropriate model management decisions based on the provided information. Model monitoring may involve the UE 3 transmitting a set of information to the network (e.g., the base station 5) including one or more of: 1) AI/ML prediction output; and 2) ground truth data: results of measurements which are performed by the UE 3 which can be used by the network (e.g., the base station 5) to determine whether the AI/ML prediction output is correct or wrong. It is assumed that both the above information are provided by the UE 3 to the network (e.g., the base station 5) within a single message and call, such as in a report “performance reporting”.

The network model monitoring framework may involve the following stages: determining UE capability for monitoring; network (e.g., the base station 5) configuration for performance reporting; UE performance reporting procedure; and UE performance report contents. Each of these stages will be discussed in more detail below.

### UE Capability for Monitoring

The inventors have realised that since the required UE reporting/measurement will be different for different AI/ML functionality/models, UE capability reporting should be defined indicating which reporting/measurement features the UE supports. To address this problem, the inventors propose to extend the current UE capability reporting to include information indicating which reporting quantities/metrics the UE 3 can support for AI/ML performance reporting for each AI/ML functionality/model. Further, since the measurements required for AI/ML performance reporting can be quite resource intensive, different UEs 3 may have different capabilities in terms of how often the UE 3 can perform the measurements, and therefore, the inventors propose that the UE 3 also indicates how frequently (time periodicity) it can perform one or more measurements for AI/ML performance reporting per AI/ML functionality/model.

The inventors also propose to define a dynamic UE capability. In this case, if the network (e.g., the base station 5) configures monitoring/activation to the UE 3 for one or more AI/ML functionalities, then the UE 3 can indicate whether or not it can support the monitoring procedure. This can be dependent on various internal UE factors like power consumption, battery level, internal capability for inference measurements which may be determined based on network provided configuration whether or not the UE 3 is capable of supporting the monitoring procedure.

The inventors have also realised that the network (e.g., the base station 5) may want the UE 3 to support AI/ML performance reporting without the UE 3 using the AI/ML model to make predictions that are used to control the UE/network RAN operation. This may be the case if the network is testing or validating an AI/ML model prior to deployment. At this stage, the network (e.g., the base station 5) may simply want to determine the prediction accuracy of the AI/ML model prior to deployment. In order to support this operation, the inventors propose that the network provide separate network indications for 1) Model Management Decisions, and 2) AI/ML Performance Reporting. In this way, the network can provide an indication to activate/deactivate/switch/fallback an AI/ML model using the first indication and can separately indicate if the UE 3 should perform AI/ML performance reporting. The indications may be provided in different messages or as different fields within a single message.

For instance, the network (e.g., the base station 5) may ask the UE 3 to run an AI/ML model for CSI-RS beam prediction and report the prediction results to the network. At the same time, it may configure the UE to perform legacy CSI-RS measurements for normal radio operation (i.e., without any AI/ML model assistance). The network may transmit separate messages to the UE 3 for model management and performance reporting, where one message is for model activation/deactivation/switching/fallback and the other message is to enable/disable AI/ML performance reporting. Alternatively, the network may transmit a single message for both model management and performance reporting where one field within the message is for the model management decision (activation/deactivation/switching/fallback) and other field is to enable/disable AI/ML performance reporting.

The UE 3 will only use the AI/ML model for RAN operation when the model is activated by the network (e.g., the base station 5) and if it is not activated but AI/ML performance reporting is enabled, then the UE 3 operates the model only for AI/ML performance reporting, and the AI/ML model is not used for RAN operation.

In the case where multiple AI/ML models are present for the same AI/ML functionality, then it is possible that the network (e.g., the base station 5) may want the UE 3 to activate one AI/ML model for RAN operation, but to run another AI/ML model for AI/ML performance reporting for testing purposes for the same AI/ML functionality. The inventors propose that the UE 3 may indicate its capability to simultaneously operate multiple AI/ML models for the same AI/ML functionality. This capability may be AI/ML functionality/model specific. In the case where the UE 3 is capable of simultaneously operating multiple AI/ML models, then the network (e.g., the base station 5) can configure different AI/ML models for activation (RAN operation) and AI/ML performance monitoring. The UE 3 would then use the AI/ML model that is activated for RAN operation and it would use the AI/ML model for performance reporting only.

### Network Configuration for Performance Reporting

The inventors propose that the network (e.g., the base station 5) configures AI/ML performance reporting per AI/ML functionality. To allow for this, the network (e.g., the base station 5) should include a functionality identifier (ID) within the configuration to indicate to the UE 3 the AI/ML functionality for which AI/ML performance reporting needs to be performed. Further, as each AI/ML functionality may be associated with more than one AI/ML model or model configuration (e.g., input/output configuration), there may be a need for the network (e.g., the base station 5) to also indicate the model/model configuration for which performance reporting should be performed. This may be achieved by including a model identifier (ID) within the configuration message that the network sends to the UE 3, that uniquely identifies the AI/ML model for which performance reporting is to be initiated. Alternatively, the configuration of the model (e.g. the input-output configuration) can be included within the configuration message to provide a full description of the model that the UE 3 is to use for performance monitoring.

The network (e.g., the base station 5) can configure an independent Radio Bearer (RB) that the UE 3 should use for performance reporting, where the RB parameters and QoS parameters are defined specifically for data collection requirements for Life Cycle Management (LCM). For example, a Data Radio Bearer (DRB) can be defined such that the UE's performance reporting is sent to an external server directly.

### UE Measurement Procedure

Performing measurements for AI/ML performance reporting can require the UE 3 to operate the AI/ML model and to perform legacy measurements (to provide ground truth data for the AI/ML model), which can be significantly power consuming for the UE 3. Further, the UE 3 may take time to complete measurements for AI/ML inference and for measuring ground truth data. The UE 3, therefore, has to know how frequently the UE 3 needs to perform the required measurements and the timing of when it should perform legacy measurements so that they correspond to the AI/ML performance measurements. The inventors propose defining a ‘UE measurement occasion selection for AI/ML performance reporting’ parameter which specifies an occasion and periodicity of the AI/ML model measurements. This information may be specified to the UE 3 by the network (e.g., the base station 5) when the network is configuring the UE for AI/ML performance reporting. Alternatively, the UE 3 may decide its own measurement occasions periodicity based on its own capability or the periodicity of reference signals/other signals that it uses for its measurements; or based on a reporting periodicity provided by the network (e.g., the base station 5) or based on a maximum/minimum periodicity value that is either configured by the network or pre-programmed into the UE 3.

With regard to performing measurements for the ground truth data, given that the ground truth data is being provided to determine the accuracy of the AI/ML prediction output, the UE 3 needs to complete the measurements for ground truth data within a defined time period of the time instance associated with the AI/ML prediction output. For example, if the AI/ML use case is CSI-RS beam prediction for time occasion T, then all the CSI-RS measurements associated with determining the performance of the AI/ML prediction output should be performed within the time period {T−Threshold, T+Threshold}. The time limit/threshold value is either pre-programmed into the UE 3 or may be configured by the network (e.g., the base station 5) and different values can be defined for different AI/ML functionalities/models. If the UE 3 cannot perform all the measurements within the time limit then the UE 3 should indicate to the network within the performance report the valid measurements that it was able to perform within the time limit.

### UE Reporting Procedure

Once the UE 3 has performed the required measurements, the UE 3 needs to know when to report them. The inventors propose that the network (e.g., the base station 5) defines this with a ‘Reporting Occasions Configuration’ which it sends to the UE 3. One option (Alt-1) for this configuration is for the network (e.g., the base station 5) to define the reporting periodicity to the UE 3. As the use case requirements for each AI/ML model may be different (e.g., the model requirements for an AI/ML model for beam prediction based on SSB may have a different required periodicity of reporting as compared to the periodicity of reporting required by an AI/ML model used for determining CSI compression parameters), different periodicity values are defined by the network (e.g., the base station 5) for each AI/ML model.

Instead of the network (e.g., the base station 5) defining the reporting periodicity to the UE 3, as an alternative (Alt-2) the network (e.g., the base station 5) may define (for each AI/ML model) one or more triggers that define when the UE 3 should transmit the AI/ML measurement report. The trigger can be based on one or more metrics and can cover either cases where AI/ML model is not performing well or cases where the AI/ML model is performing well. For example, the network (e.g., the base station 5) can configure an AI/ML measurement metric (e.g., AI/ML prediction accuracy) and configure an event that the UE 3 reports to the network if the AI/ML performance metric is better than a first threshold value and/or an event that the UE 3 reports to the network if the AI/ML performance metric is worse than a second threshold value. As a further alternative (Alt-3), the network (e.g., the base station 5) may poll (indicate to) the UE 3 when it wants the UE 3 to perform AI/ML performance reporting. In response, the UE 3 would compile the reporting metrics and other associated measurement results for reporting to the network (e.g., the base station 5).

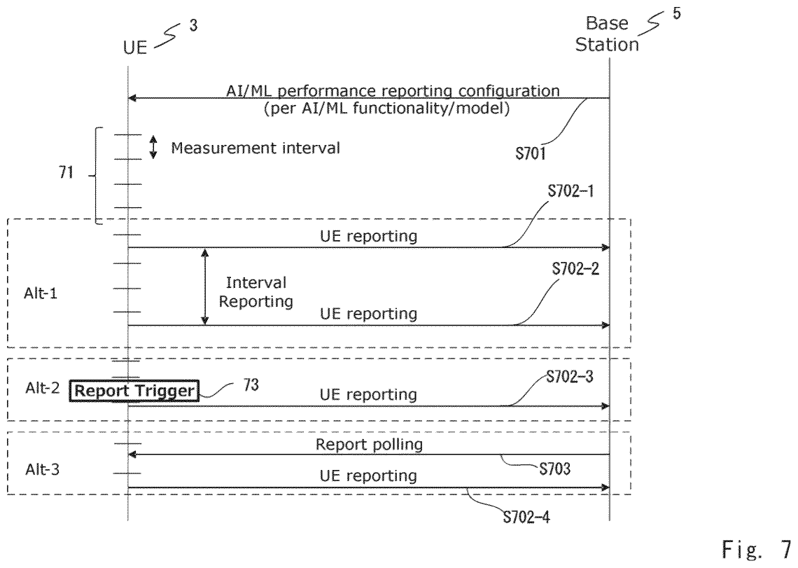

These different reporting options are illustrated in FIG. 7. As shown, the base station 5 starts the procedure by transmitting, in step S701, an AI/ML performance reporting configuration to the UE 3. The UE 3 then performs the configured measurements, some of which are labelled 71. The measurements are performed periodically with a measurement interval between successive measurements. The upper dashed box shown in FIG. 7 (labelled Alt-1) illustrates the first alternative described above where the UE 3 performs the measurements and then reports periodically (in steps S702-1 and S702-2) with the time between reports being defined by the period labelled “interval reporting” in FIG. 7. The middle dashed box shown in FIG. 7 (labelled Alt-2) illustrates the second alternative described above where the base station 5 configures the UE 3 to send, in step S702-3, the report in response to some event “report trigger” 73. As discussed this report trigger 73 may be that the AI/ML model performance quality is better than a threshold. The lower dashed box shown in FIG. 6 (labelled Alt-3) illustrates the third alternative described above where the base station 5 sends, in step S703, a report polling message to the UE 3 when the base station 5 wants the UE 3 to report the AI/ML performance measurements, which the UE 3 does in step S702-4.

### Reporting for UE Model Monitoring

In the case of UE model monitoring, the UE 3 needs to determine whether an AI/ML model is working properly or not and this determination can be assisted based on information from the network (e.g., the base station 5) or based on predefined (pre-stored or pre-programmed) information or rules.

For example, the UE 3 may monitor one or more monitoring metrics related to the AI/ML model/functionality within a time window. The Monitoring metrics are either configured by the network or predefined for an AI/ML model/functionality. An example monitoring metric can be the AI/ML model prediction error (other detailed metrics are described below). The UE 3 uses at least one criterion based on which the UE decides what model management action (e.g., activation/deactivation) to take. The at least one criterion can be in the form of a threshold check of the monitoring metric where the at least one criterion and its associated parameters (e.g., threshold value) can be pre-programmed in the UE 3 or can be configured by the network (e.g., the base station 5) to the UE 3.

Multiple criteria can be defined/configured where each criterion can be associated to one model management decision type (e.g., for model activation, the network may provide one criterion and for model deactivation the network may provide a different criterion). The time window over which the UE performs the monitoring may be configured by the network or selected by the UE 3.

When a criteria check is successful, the UE 3 performs one of the following procedures:

Option-1: the UE 3 takes a decision for model management (e.g., activate/deactivate/switch) of the AI/ML model and indicate the decision to the network (e.g., the base station 5). The model management decision taken is the decision associated with the criterion which is considered successful. The UE 3 transmits a report to the base station 5 indicating the criterion being met and waits for a certain time delay before implementing the model management decision. This delay allows the network time to perform any radio reconfiguration. The report can indicate the AI/ML model/functionality identifier and either the model management decision taken by the UE 3 (e.g., activation/deactivation) or the identification of the at least one criterion which has been successful. Different values of delay can be specified/configured for different model management actions.

Option-2: the UE 3 sends a report to the network (e.g., the base station 5) and the UE 3 waits for confirmation of the decision from the network. In this case the report sent by the UE 3 to the base station 5 may indicate the AI/ML model/functionality identifier and either the model management decision taken by the UE 3 (e.g., activation/deactivation) or the identification of the at least one criterion which has been successful. The network response can be either in the form of an accept or a reject message or it can contain the model management decision which should be taken by the UE 3.

These different reporting options are illustrated in FIG. 8. As shown, in step S801, the base station 5 sends the UE 3 a UE monitoring configuration via RRC signalling. This is provided per AI/ML functionality/model. The UE 3 then performs the configured measurements, some of which are labelled 81. The measurements are performed periodically with a measurement interval between successive measurements. Each time one or more measurements are performed, the UE 3 checks to see if one or more measurements meet the defined at least one criterion. In the example scenario illustrated in FIG. 8, the last illustrated measurement is found to meet the at least one criterion for reporting.

The upper dashed box shown in FIG. 8 (labelled Option-1) illustrates the first option described above where, in the case that the measurement indicates that the AI/ML model or functionality meets the at least one criterion, the UE 3 reports (in step S802-1) to the base station 5. As discussed above, the report can indicate the AI/ML model/functionality identifier and either the model management decision taken by the UE 3 (e.g., activation/deactivation) or the identification of the at least one criterion which has been successful. The UE 3 then waits for a period of time (indicated as “Action delay” in FIG. 8) before implementing, in step S803, the decided management decision (activate/deactivate/switch/fallback).

The lower dashed box in FIG. 8 (labelled Option-2) illustrates the second option described above where, in the case that the measurement indicates that the AI/ML model or functionality meets the at least one criterion, the UE 3 reports, in step S802-2, to the base station 5 indicating the AI/ML model/functionality identifier and either the model management decision taken by UE 3 (e.g., activation/deactivation) or the identification of the at least one criterion which has been successful. The UE 3 then waits to receive, in step S804, for the network response message which can be either in the form of an accept or a reject message or it can contain the model management decision which should be taken by the UE 3.

### Lower Layer UE Reporting

Some AI/ML use cases may require low latency performance reporting. For example, if UE based performance reporting is used and the UE 3 determines, for example, that the beam prediction algorithm is not performing well, then the UE 3 should send the report to the network immediately to ensure that the network can take action as soon as possible. Hence, lower layer based reporting is advantageous for such a situation. In order to allow such reporting in the lower layers (e.g., MAC CE/UCI), a mechanism needs to be defined on how information is reported by the UE 3 to the network (e.g., the base station 5). The inventors have proposed the following reporting mechanisms:

### Reporting via UCI

A new UCI (Uplink Control Information) may be defined (as compared to UCI used for ACK/NACK, CSI, SR) if number of bits for AI/ML performance reporting is greater than a threshold. If number of bits is smaller than the threshold then same UCI can be used for reporting as UCI is used for reporting ACK/NACK/CSI/SR reporting. For the case when 2 different UCIs are used by the UE one for AI/ML performance reporting and other for ACK/NACK/SR/CSI reporting, the network (e.g. the base station 5) can identify the type of UCI based on a number of factors including one or more of following:
A UCI id can be included within the UCI to indicate to the network the type of UCI.
Each UCI type transmission is associated with a set of radio resources (e.g. time, frequency resources and/or carrier). The network, upon receiving the UCI, can determine the type of UCI based on the radio resources on which UCI is received.
Each UCI type transmission is associated to a set of physical channels. For example, UCI for AI/ML performance reporting is transmitted within a configured “UL configured grant” PUSCH resource whereas the UCI for ACK/NACK/SR/CSI is transmitted on other PUSCCH or PUSCH resources. Based on the physical channel on which the UCI is received, the network can determine the type of the UCI.

### Reporting via MAC CE

New LCID (Logical Channel Identifier) values may be defined indicating a UE inference report for AI/ML. In one option, a single LCID value can be used for multiple AI/ML functionality/models. Alternatively, different LCID values can be defined for different AI/ML functionality/models. A variable size MAC (Medium Access Control) CE (Control Element) may be defined for the reporting, where the size of the MAC CE is either reported by the UE 3 within the MAC CE or configured by the network (e.g., based on reporting configuration).

The above options may only be possible when the reporting content is less than a certain threshold and hence for the case where the UE 3 needs to transmit a larger payload, the inventors propose one of the following options:
Option-1: the UE 3 sends the base station 5 part of the payload (e.g., only indicating model management decision or model failure) via lower layers and the remaining payload is sent to the base station via RRC signalling.
Option-2: the UE 3 sends the base station 5 the payload via a lower layer report if the payload size is less than the threshold otherwise the UE 3 sends the base station 5 the report via RRC signalling.
Option-3: Different channel types (e.g., RRC or MAC CE or UCI) is used by the UE 3 for different type of reports that are sent to the base station 5. For example, the UE 3 may use RRC signalling for transmission of regular performance monitor reporting when the AI/ML algorithm is working properly, but the UE 3 may use UCI/MAC CE for reporting when the UE 3 needs to be report failure of AI/ML operation or when the AI/ML functionality is not working properly.

The selection of the type of information to be transmitted over which channel can be either pre-programmed into the UE 3 or can be configured by the network (e.g., the base station 5).

### Reporting Content

Multiple different metrics can be defined specific to each AI/ML use case for UE reporting or criteria check. The network (e.g., the base station 5) may configure the metrics which shall be used by the UE 3 or they can be pre-programmed in the UE 3. The metrics can be of 2 types:
Type-1: Performance metrics e.g., user throughput, handover failure/success rate, beam failure rate, BLER, etc.
Type-2: AI/ML prediction metric: How well an AI/ML operation is performing.

The network (e.g., the base station 5) can configure the UE 3 to consider both types of metrics or only one type of metric, for performance reporting. Some examples of AI/ML prediction metrics which can be supported for a functionality include:
1) The number/percentage of instances when the AI/ML model was used to perform the required RAN procedure (as compared to the legacy procedure). This information may be helpful for the case where the UE 3 determines not to use an AI/ML model for a particular functionality (e.g., beam prediction) if it observes that the accuracy or the confidence percentage of the AI/ML output is not above a certain threshold. This may also be helpful when the AI/ML model is not run by the UE 3 because of issues in the input feature data (e.g., missing or incorrect input features). In addition or alternatively, the UE 3 could be configured to provides the combined number of instances where the AI/ML model is not run. This information may be provided together with one or more reasons for not running the AI/ML model (e.g., low confidence in AI/ML prediction or missing data, etc.). The UE 3 may also be configured to provide, for each reason (e.g., low confidence or incorrect/missing data), the number of instances when AI/ML model is not run.
2) For a classification problem, a typical metric that is reported can be the confusion matrix, which is a table (such as the one shown below) where a row of the matrix represents the instances in an actual class while each column represents the instances in a predicted class, or vice versa. In the example below, the actual class can be positive or negative and the prediction is either positive or negative. So, where the prediction is positive and the actual class is positive, this is termed a “true positive”; where the prediction is positive and the actual class is negative, this is termed a “false positive”; where the prediction is negative and the actual class is positive, this is termed a “false negative”; and where the prediction is negative and the actual class is negative, this is termed a “true negative”. The metric which can be reported by the UE 3 can either be the confusion matrix or a set of parameters which are derived from the confusion matrix (e.g., true positive, false positive, etc.)

| | Predicted = positive | Predicted = negative |
|---|---|---|
| Actual = positive | True Positive (TP) | False Negative (FN) |
| Actual = negative | False Positive (FP) | True Negative (TN) |

3) If the AI/ML model predicts the N best objects (for example, the N best beams, or the N best cells, or the N best SSB/CSI-resources etc.), then possible metrics that the UE 3 can report include: the number of times or the percentage of times the best object predicted by the AI/ML model is within (or not within) the M best objects actually observed by the UE; and/or the number of times or the percentage of times the best object actually measured by the UE 3 is within the N best objects predicted by the AI/ML model.
4) If the AI/ML model predicts a value for a parameter (for example, a position or a CSI strength), then possible metrics can include the number or percentage of times the predicted value of the parameter is within (or not within) a threshold range of the actual observation of the same parameter; and/or the number or percentage of times the observed value of the parameter is within (or not within) a threshold range of the predicted value of the same parameter.

### Handling Mobility Events

As discussed above, the UE 3 may move from a source base station 5-1 to a target base station 5-2 (or indeed a change of cell operated by the same base station) and this affects the AI/ML models/functionality and measurements that the UE 3 is performing. When the UE 3 is handed over to a new cell or a new base station, the inventors propose that the UE 3 either discards all the stored measurements for AI/ML performance reporting associated with the source cell, or the UE 3 does not discard the stored measurements for AI/ML performance reporting associated with the source cell if AI/ML model has not changed after cell change/handover. Where the UE 3 does not discard the measurements from the source cell, the UE 3 can include the report of both the source cell and target cell in the next reporting occasion. The UE 3 may also include a cell/network node identifier with each such report. For example, the report may include the following information:
AI/ML performance report-1: Cell/network node identifier-X: measurement-1, measurement-2, . . .
AI/ML performance report-2: Cell/network node identifier-Y: measurement-1, measurement-2, . . .

The new base station (or cell) may then forward the associated inference measurements to the source base station (or cell).

In the case of centralized data collection, the new base station (cell) can also forward the data to a particular address (e.g., of an AI/ML server), as long as this information was shared by the Handover Request message from the serving base station (cell) to the target base station (cell) before the handover. However, if the target base station (cell) can benefit from the data measurement from the UE's monitoring history (e.g. its AI/ML monitoring outcome), these data/measurements can also be used by the target base station (cell) to help its AI/ML management decisions.

### Actions on Model Switch

As discussed above, where there are multiple AI/ML models for the same functionality, the base station 5 may decide to switch the AI/ML model that is being used by the UE 3. When this happens the UE 3 has to do something with the measurements that it has collected and the monitoring procedure it is using prior to the switch. One option is that the UE 3 is configured to discard any stored measurements obtained prior to the model switch and to reinitiate the monitoring procedure for the new model. Alternatively, the UE 3 may be configured to keep any stored measurements before the model switch and carry on with the monitoring procedure for the new AI/ML model and then when it is time to report the AI/ML results, the UE 3 reports the results for the old AI/ML model together with any results from the new AI/ML model. The UE 3 may also include a model identifier with each such report, so the report may include:
AI/ML performance report-1: Model identifier-X: measurement-1, measurement-2, . . .
AI/ML performance report-2: Model identifier-Y: measurement-1, measurement-2, . . .

### User Equipment

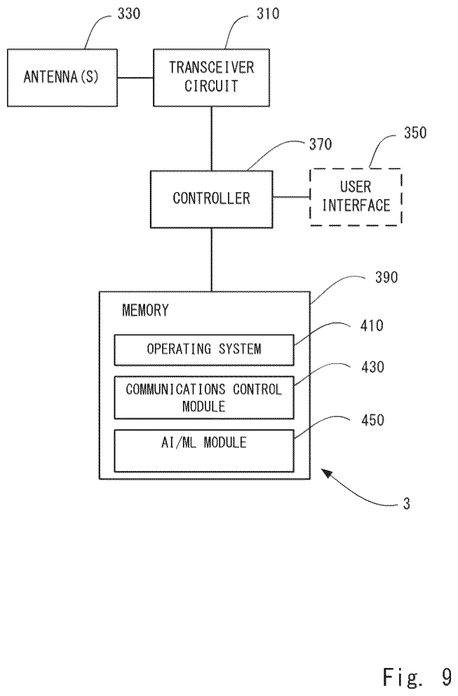

FIG. 9 is a schematic block diagram illustrating the main components of a UE 3 as shown in FIG. 1. As shown, the UE 3 has a transceiver circuit 310 that is operable to transmit signals to and to receive signals from a base station 5 via one or more antenna 330 (e.g., comprising one or more antenna elements). The UE 3 has a controller 370 (which may be a microprocessor) to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like, for allowing direct control by and interaction with a user) and this may be provided by any one or any combination of hardware, software, and firmware, as appropriate. Software may be pre-installed in the memory 390 and/or may be downloaded via the telecommunications network or from a removable data storage device (RMD), for example.

The controller 370 is configured to control the overall operation of the UE 3 by, in this example, program instructions or software instructions stored within memory 390. As shown, these software instructions include, among other things, an operating system 410, a communications control module 430, and an AI/ML module 450. The communications control module 430 is operable to control the communication between the UE 3 and its one or more serving base stations 5 (and other communication devices connected to the base station 5, such as further UEs 3 and/or core network nodes 10).

The communications control module 430 is configured for the overall handling of uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 430 is also responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The communications control module 430 may be configured to control communications in accordance with any of the methods described above (for example, to transmit a measurement report according to any of the methods described above).

The AI/ML module 450 is operable to control the use of one or more AI/ML models at the UE 3 (e.g. to generate one or more inferences using one or more models). The AI/ML module 450 is also configured to perform any of the AI/ML related functions of the UE 3 of any of the methods described above-including the making of AI/ML decisions and the performance of AI/ML measurements and the reporting of the measurement results to the network (e.g. the base station 5).

### Base Station

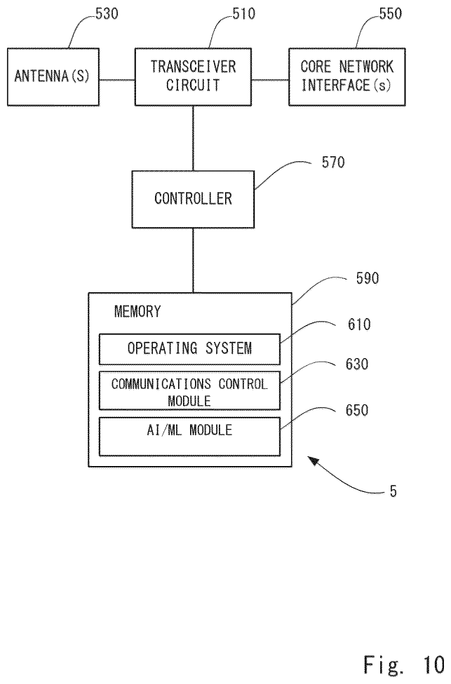

FIG. 10 is a schematic block diagram illustrating the main components of a base station 5 of the communication system 1 shown in FIG. 1. As shown, the base station 5 has a transceiver circuit 510 for transmitting signals to and for receiving signals from the communication devices (such as UEs 3) via one or more antenna 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 (which may be a microprocessor) to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within memory 590. As shown, these software instructions include, among other things, an operating system 610, a communications control module 630 and an AI/ML module 650.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like.

The AI/ML module 650 may be configured to perform any of the AI/ML related functions of the UE 3 of any of the methods described above, including running AI/ML models, deploying AI/ML models to UEs 3, taking management decisions in relation to deployed AI/ML models, configuring the UEs to perform AI/ML performance measurements and AI/ML performance reporting etc.

### Modifications and Alternatives

As those skilled in the art will appreciate, a number of modifications and alternatives can be made to the above example embodiments whilst still benefiting from the disclosure embodied therein.

Whilst the above examples have been described with reference to an AI/ML model, it will be appreciated that the above described methods are advantageous even when the model is not an AI/ML model. Any other suitable type of model or function may be used to generate inferences (e.g. determinations or predictions).

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller described above may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

One or more of the base stations 5 may comprise a ‘distributed’ base station having a central unit ‘CU’ and one or more separate distributed units ‘DUs’.

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & | Fleet Management |
| Tracing | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer | Digital photo frame |
| Devices | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a user equipment, UE, the method comprising:
transmitting UE capability information to a network node;
wherein the UE capability information indicates which reporting quantities or metrics the UE can support for model performance reporting.

### (Supplementary Note 2)

The method of supplementary note 1, wherein the UE capability information indicates the capability of the UE on how frequently the UE can perform measurement for model performance reporting for the or each model.

### (Supplementary Note 3)

The method according to supplementary note 1 or 2, wherein the method further comprises receiving a configuration from the network node to perform model performance reporting and wherein the transmitting is performed in response to receiving the configuration.

### (Supplementary Note 4)

The method according to any one of supplementary notes 1 to 3, wherein the UE capability information includes information indicating the ability of the UE to operate simultaneously multiple models for the same functionality.

### (Supplementary Note 5)

A method performed by a user equipment, UE, the method comprising:
receiving from a network node, a first indication for a model management decision and a second indication for model performance reporting;
in a case where the first indication does not indicate activation of the model and the second indication enables model performance reporting, running the model and reporting model performance to the network node without using an output from the model to control communications with the network node.

### (Supplementary Note 6)

The method according to supplementary note 5, wherein in a case where the first indication indicates activation of the model and the second indication enables model performance reporting, the method comprises running the model and using an output from the model to control communications with the network node and reporting model performance to the network node.

### (Supplementary Note 7)

The method according to supplementary note 5 or 6, wherein the first indication and the second indication are received within the same message or in different messages.

### (Supplementary Note 8)

The method according to any one of supplementary notes 5 to 7, wherein in a case where the first indication indicates a first model and the second indication indicates enabling of model performance reporting for a second model that is different from the first model, the method comprises running the first model and using an output from the first model to control communications with the network node, running the second model and reporting model performance of the second model to the network node without using an output from the second model to control communications with the network node.

### (Supplementary Note 9)

The method according to supplementary note 8, wherein the first model and the second model are for the same functionality.

### (Supplementary Note 10)

A method performed by a user equipment, UE, the method comprising:
receiving from a network node configuration data for model performance reporting in respect of plural model functionalities;
running a model for each functionality configured by the configuration data; and
reporting model performance for each model functionality in accordance with the configuration data.

### (Supplementary Note 11)

The method according to supplementary note 10, wherein the configuration data includes a functionality identifier for each functionality for which model performance reporting is required.

### (Supplementary Note 12)

The method according to supplementary note 11, wherein the configuration data further comprises a model identifier for at least one model functionality, that identifies which one of a plurality of models or model configurations associated with the at least one model functionality is to be run and for which model performance reporting is to be performed.

### (Supplementary Note 13)

The method according to any one of supplementary notes 11 to 12, wherein the configuration data further comprises model configuration data for at least one model functionality, that configures a model that is to be run and for which model performance reporting is to be performed.

### (Supplementary Note 14)

The method according to any one of supplementary notes 11 to 13, wherein the configuration data comprises data for configuring a radio bearer between the UE and a network node that is used for the model performance reporting.

### (Supplementary Note 15)

A method performed by a user equipment, UE, the method comprising:
running, at a first time, a model that predicts a parameter relating to a communication with a network node;
obtaining at least one measurement of at least one signal that relates to the parameter that is predicted by the model and that is received by the user equipment around the first time; and
reporting the parameter predicted by the model and the at least one measurement to the network node.

### (Supplementary Note 16)

The method according to supplementary note 15, comprising repeating the running and obtaining at different times and wherein the reporting reports the parameter predicted by the model and the at least one measurement for each repetition of the running and obtaining.

### (Supplementary Note 17)

The method according to supplementary note 16, wherein the running and the repeating are performed periodically.

### (Supplementary Note 18)

The method according to supplementary note 17, comprising receiving configuration data from the network node that defines the periodicity at which the running and obtaining are repeated.

### (Supplementary Note 19)

The method according to supplementary note 17, wherein the UE decides on occasions when the running and obtaining are repeated based on a capability of the UE or based on a periodicity of the reception of the at least one signal used for the measurement.

### (Supplementary Note 20)

The method according to any one of supplementary notes 15 to 19, wherein in a case where the UE is unable to obtain all measurements within a reporting interval, the reporting indicates the measurements that the UE was able to perform within the reporting interval.

### (Supplementary Note 21)

The method according to any one of supplementary notes 15 to 20, wherein the obtaining obtains the at least one measurement within a predetermined time period of the first time.

### (Supplementary Note 22)

The method according to supplementary note 21, wherein the predetermined time period is prestored in the UE or is defined in configuration data that is received from the network node.

### (Supplementary Note 23)

The method according to supplementary note 21 or 22, wherein the predetermined time period depends on a functionality of the model.

### (Supplementary Note 24)

The method according to any one of supplementary notes 15 to 23, comprising receiving configuration data from the network node that indicates one or more reporting occasions when the UE should perform the reporting.

### (Supplementary Note 25)

The method of supplementary note 24, wherein the configuration data defines a periodicity for reporting and wherein the periodicity depends on a functionality of the model.

### (Supplementary Note 26)

The method according to any one of supplementary notes 15 to 23, comprising receiving configuration data from the network node that indicates one or more triggers that when met, cause the UE to perform the reporting.

### (Supplementary Note 27)

The method according to supplementary note 26, wherein the trigger defines a model prediction metric and the reporting is performed in dependence on the model prediction metric.

### (Supplementary Note 28)

The method according to supplementary note 26, wherein the configuration data configures the UE to perform the reporting in a case where a prediction metric of the model is better or worse than a threshold value.

### (Supplementary Note 29)

The method according to any one of supplementary notes 15 to 28, wherein the UE performs the reporting in response to receiving a request from the network node.

### (Supplementary Note 30)

A method performed by a user equipment, UE, the method comprising:
running a model that predicts a parameter relating to a communication with a network node;
monitoring at least one metric related to the model or to the communication with the network node; and
reporting to the network node in a case where the at least one metric meets at least one criterion.

### (Supplementary Note 31)

The method according to supplementary note 30, comprising receiving configuration data from the network node that defines the at least one metric and/or that defines the at least one criterion.

### (Supplementary Note 32)

The method according to supplementary note 30, wherein the at least one metric and/or the at least one criterion are prestored within the UE.

### (Supplementary Note 33)

The method according to any one of supplementary notes 30 to 32, wherein there are plural possible model management decisions and at least one criterion is provided for each possible model management decision.

### (Supplementary Note 34)

The method according to any one of supplementary notes 30 to 33, wherein the at least one criterion is a threshold check of the one or more metrics.

### (Supplementary Note 35)

The method according to any one of supplementary notes 30 to 34, wherein the monitoring is performed over a defined time window.

### (Supplementary Note 36)

The method according to any one of supplementary notes 30 to 35, further comprising making a model management decision based on the at least one metric and the at least one criterion.

### (Supplementary Note 37)

The method according to supplementary note 36, wherein the model management decision is one of: model activation, model deactivation, model switch and model fallback.

### (Supplementary Note 38)

The method according to supplementary note 36 or 37, wherein the reporting indicates the model management decision taken by the UE.

### (Supplementary Note 39)

The method according to supplementary note 38, wherein the UE waits a period of time after reporting the model management decision before implementing the model management decision.

### (Supplementary Note 40)

The method according to supplementary note 38 or 39, wherein the reporting indicates the model management decision by indicating the at least one criterion that has been met by the monitored at least one metric.

### (Supplementary Note 41)

The method according to any one of supplementary notes 30 to 35, further comprising receiving an indication of a model management decision from the network node after the reporting, and implementing the model management decision.

### (Supplementary Note 42)

The method according to any one of supplementary notes 30 to 41, wherein the reporting includes an identifier for the model.

### (Supplementary Note 43)

The method according to any one of supplementary notes 30 to 42, wherein the metric relates to the performance of the communication with the network node and is selected from the group comprising: user throughput, handover failure/success rate, beam failure rate, Block Error Rate, BLER.

### (Supplementary Note 44)

The method according to any one of supplementary notes 30 to 42, wherein the metric relates to the performance of the model indicating how well the model is performing.

### (Supplementary Note 45)

The method according to supplementary note 44, wherein the metric comprises an indication of a number of instances the model was used to control communications with the network node.

### (Supplementary Note 46)

The method according to supplementary note 44 or 45, wherein the metric comprises an indication of a number of instances the model was not used to control communications with the network node.

### (Supplementary Note 47)

The method according to supplementary note 46, wherein the reporting indicates a number of instances the model was not used to control communications with the network node together with one or more reasons for not using the model.

### (Supplementary Note 48)

The method according to supplementary note 47, wherein in a case where there are plural reasons why a model is not used, the reporting indicates, for each reason, a number of instances the model was not used to control communications with the network node.

### (Supplementary Note 49)

The method according to any one of supplementary notes 30 to 44, wherein the model is a classification model and wherein the metric comprises a confusion matrix of the model.

### (Supplementary Note 50)

The method according to supplementary note 49, wherein the reporting comprises the confusion matrix or parameters derived from the confusion matrix.

### (Supplementary Note 51)

The method according to any one of supplementary notes 30 to 44, wherein the model is configured to predict measurement of N best objects and wherein the metric comprises an indication of a number of instances a best object predicted by the model is within M best objects observed by the UE.

### (Supplementary Note 52)

The method according to any one of supplementary notes 30 to 44, wherein the model is configured to predict measurement of N best objects and wherein the metric comprises an indication of a number of instances a best object measured by the UE is within the N best objects predicted by the model.

### (Supplementary Note 53)

The method according to any one of supplementary notes 30 to 44, wherein the model is configured to predict a value of a parameter and wherein the metric comprises an indication of a number of instances the predicted value of the parameter is within a threshold range of a measurement of that parameter.

### (Supplementary Note 54)

The method according to any one of supplementary notes 30 to 44, wherein the model is configured to predict a value of a parameter and wherein the metric comprises an indication of a number of instances a measured value of the parameter is within a threshold range of a predicted value of the parameter from the model.

### (Supplementary Note 55)

The method according to any one of supplementary notes 5 to 54, wherein in a case of low latency reporting, the reporting is performed via an Uplink Control Information UCI message.

### (Supplementary Note 56)

The method according to any one of supplementary notes 5 to 54, wherein in a case of low latency reporting, the reporting is performed via a Medium Access Control, MAC, Control Element, CE.

### (Supplementary Note 57)

The method according to supplementary note 56, wherein the MAC CE includes a Logical Chanel Identifier, LCID that indicates that the message comprises a model report.

### (Supplementary Note 58)

The method according to supplementary note 57, wherein the reporting is for multiple models and wherein an LCID value is provided for each model or a single LCID value is used for the multiple models.

### (Supplementary Note 59)

The method according to any one of supplementary notes 5 to 58, wherein depending on the amount of data to be transmitted to the network node in the reporting, the UE sends a part of the data in an Uplink Control Information UCI message or in a Medium Access Control, MAC, Control Element, CE message and a part of the data in a Radio Resource Control, RRC, message.

### (Supplementary Note 60)

The method according to any one of supplementary notes 5 to 58, wherein depending on the amount of data to be transmitted to the network node in the reporting, the UE sends the data in an Uplink Control Information UCI message or in a Medium Access Control, MAC, Control Element, CE message in a case where the amount of data is less than a threshold amount and sends the data in a Radio Resource Control, RRC, message otherwise.

### (Supplementary Note 61)

The method according to any one of supplementary notes 5 to 60, wherein the reporting is performed via an Uplink Control Information UCI message, a Medium Access Control, MAC, Control Element, CE message or a Radio Resource Control, RRC, message depending on a type of report that is reported.

### (Supplementary Note 62)

The method according to any one of supplementary notes 5 to 61, wherein in a case where the UE changes to a target cell of a network node with which the UE communicates, the UE discards stored measurements relating to a source cell of the network node.

### (Supplementary Note 63)

The method according to any one of supplementary notes 5 to 61, wherein in a case where the UE changes to a target cell of a network node with which the UE communicates, the UE does not discard stored measurements relating to a source cell of the network node and includes the stored measurements relating to the source cell in the reporting.

### (Supplementary Note 64)

The method according to supplementary note 63, wherein the reporting includes measurements relating to the source cell in the reporting and measurements relating to the target cell in the reporting.

### (Supplementary Note 65)

The method according to any one of supplementary notes 5 to 64, wherein in a case where a model is changed, the UE discards any stored measurements prior to the model switch and reinitiates performance monitoring after the model switch.

### (Supplementary Note 66)

The method according to any one of supplementary notes 5 to 64, wherein in a case where a model is changed, the UE keeps any stored measurements prior to the model switch.

### (Supplementary Note 67)

The method according to supplementary note 66, wherein the reporting includes measurements for the model before the switch and measurements for the model after the model switch.

### (Supplementary Note 68)

A method performed by a network node, the method comprising:
receiving from a user equipment, UE, UE capability information;
wherein the UE capability information indicates which reporting quantities or metrics the UE can support for model performance reporting.

### (Supplementary Note 69)

The method of supplementary note 68, wherein the UE capability information indicates the capability of the UE on how frequently the UE can perform measurement for model performance reporting for the or each model.

### (Supplementary Note 70)

The method according to supplementary note 68 or 69, wherein the method further comprises transmitting to the UE a configuration to perform model performance reporting and wherein the receiving is performed in response to transmitting the configuration.

### (Supplementary Note 71)

The method according to any one of supplementary notes 68 to 70, wherein the UE capability information includes information indicating the ability of the UE to operate simultaneously multiple models for the same functionality.

### (Supplementary Note 72)

A method performed by a network node, the method comprising:
transmitting to a user equipment, UE, a first indication for a model management decision and a second indication for model performance reporting;
in a case where the first indication does not indicate activation of the model and the second indication enables model performance reporting, receiving a report from the UE of model performance in respect of a model that is run on the UE without using an output from the model to control communications with the network node.

### (Supplementary Note 73)

The method according to supplementary note 72, wherein in a case where the first indication indicates activation of the model and the second indication enables model performance reporting, the method comprises using an output from the model to control communications between the UE and the network node and receiving a report from the UE of model performance in respect of the model that is run on the UE.

### (Supplementary Note 74)

The method according to supplementary note 72 or 73, wherein the first indication and the second indication are transmitted within the same message or in different messages.

### (Supplementary Note 75)

The method according to any one of supplementary notes 72 to 74, wherein in a case where the first indication indicates a first model and the second indication indicates enabling of model performance reporting for a second model that is different from the first model, the method comprises using an output from the first model that is run by the UE to control communications between the UE and the network node, and receiving a report from the UE of model performance in respect of the second model that is run on the UE without using an output from the second model to control communications between the UE and the network node.

### (Supplementary Note 76)

The method according to supplementary note 75, wherein the first model and the second model are for the same functionality.

### (Supplementary Note 77)

A method performed by a network node, the method comprising:
transmitting to a user equipment, UE, configuration data for model performance reporting in respect of plural model functionalities; and
receiving model performance data from the UE in respect of running a model for each functionality configured by the configuration data for each model functionality in accordance with the configuration data.

### (Supplementary Note 78)

The method according to supplementary note 77, wherein the configuration data includes a functionality identifier for each functionality for which model performance reporting is required.

### (Supplementary Note 79)

The method according to supplementary note 78, wherein the configuration data further comprises a model identifier for at least one model functionality, that identifies which one of a plurality of models or model configurations associated with the at least one model functionality is to be run and for which model performance reporting is to be performed.

### (Supplementary Note 80)

The method according to any one of supplementary notes 77 to 79, wherein the configuration data further comprises model configuration data for at least one model functionality, that configures a model that is to be run and for which model performance reporting is to be performed.

### (Supplementary Note 81)

The method according to any one of supplementary notes 77 to 80, wherein the configuration data comprises data for configuring a radio bearer between the UE and a network node that is used for the model performance reporting.

### (Supplementary Note 82)

A method performed by a network node, the method comprising:
configuring a user equipment, UE, to run, at a first time, a model that predicts a parameter relating to a communication between the UE and the network node;
wherein the UE obtains at least one measurement of at least one signal that relates to the parameter that is predicted by the model and that is received by the user equipment around the first time; and
receiving a report from the UE including the parameter predicted by the model and the at least one measurement.

### (Supplementary Note 83)

The method according to supplementary note 82, wherein the UE repeatedly runs the model and obtains corresponding measurements at different times and wherein the report includes the parameter predicted by the model and the at least one measurement for each repetition.

### (Supplementary Note 84)

The method according to supplementary note 83, comprising transmitting configuration data to the UE that defines a periodicity at which the UE should run the model and obtains the at least one measurement.

### (Supplementary Note 85)

The method according to supplementary note 83 or 84, wherein in a case where the UE is unable to obtain all measurements within a reporting interval, the received report includes an indication of the measurements that the UE was able to perform within the reporting interval.

### (Supplementary Note 86)

The method according to any one of supplementary notes 82 to 85, wherein at least one measurement is obtained within a predetermined time period of the first time.

### (Supplementary Note 87)

The method according to supplementary note 86, comprising sending configuration data to the UE to define the predetermined time period.

### (Supplementary Note 88)

The method according to supplementary note 86 or 87, wherein the predetermined time period depends on a functionality of the model.

### (Supplementary Note 89)

The method according to any one of supplementary notes 82 to 88, comprising transmitting configuration data to the UE that indicates one or more reporting occasions when the UE should send the report.

### (Supplementary Note 90)

The method according to supplementary note 82 to 88, comprising transmitting configuration data to the UE that indicates one or more triggers that when met, cause the UE to send the report.

### (Supplementary Note 91)

The method according to supplementary note 90, wherein the trigger defines a model prediction metric and the reporting is performed in dependence on the model prediction metric.

### (Supplementary Note 92)

The method according to supplementary note 90, wherein the configuration data configures the UE to perform the reporting in a case where a prediction metric of the model is better or worse than a threshold value.

### (Supplementary Note 93)

The method according to any one of supplementary notes 82 to 92, comprising transmitting a request to the UE to send the report to the network node.

### (Supplementary Note 94)

A method performed by a network node, the method comprising:
configuring a user equipment, UE, to run a model that predicts a parameter relating to a communication with the network node;
wherein the UE monitors at least one metric related to the model or to the communication with the network node; and
receiving a report from the UE in a case where the at least one metric meets at least one criterion.

### (Supplementary Note 95)

The method according to supplementary note 94, comprising transmitting configuration data to the UE that defines the at least one metric and/or that defines the at least one criterion.

### (Supplementary Note 96)

The method according to supplementary note 94 or 95, wherein there are plural possible model management decisions and at least one criterion is provided for each possible model management decision.

### (Supplementary Note 97)

The method according to any one of supplementary notes 94 to 96, wherein the at least one criterion defines a threshold check of the one or more metrics.

### (Supplementary Note 98)

The method according to any one of supplementary notes 94 to 97, wherein the monitoring is performed over a defined time window.

### (Supplementary Note 99)

The method according to any one of supplementary notes 94 to 98, wherein the UE makes a model management decision based on the at least one metric and the at least one criterion and the report indicates the model management decision taken by the UE.

### (Supplementary Note 100)

The method according to supplementary note 99, further comprising adjusting radio parameters in accordance with the model management decision taken by the UE.

### (Supplementary Note 101)

The method according to supplementary note 99 or 100, wherein the report indicates the model management decision by indicating the at least one criterion that has been met by the monitored at least one metric.

### (Supplementary Note 102)

The method according to any one of supplementary notes 94 to 98, further comprising making a model management decision based on the report and transmitting an indication of the model management decision to the UE, and implementing the model management decision.

### (Supplementary Note 103)

The method according to any one of supplementary notes 94 to 102, wherein the reporting includes an identifier for the model.

### (Supplementary Note 104)

The method according to any one of supplementary notes 94 to 103, wherein the metric relates to the performance of the communication with the network node and is selected from the group comprising: user throughput, handover failure/success rate, beam failure rate, Block Error Rate, BLER.

### (Supplementary Note 105)

The method according to any one of supplementary notes 94 to 103, wherein the metric relates to the performance of the model indicating how well the model is performing.

### (Supplementary Note 106)

The method according to supplementary note 105, wherein the metric comprises an indication of a number of instances the model was used to control communications with the network node.

### (Supplementary Note 107)

The method according to supplementary note 105 or 106, wherein the metric comprises an indication of a number of instances the model was not used to control communications with the network node.

### (Supplementary Note 108)

The method according to supplementary note 107, wherein the report indicates a number of instances the model was not used to control communications with the network node together with one or more reasons for not using the model.

### (Supplementary Note 109)

The method according to supplementary note 108, wherein in a case where there are plural reasons why a model is not used, the report indicates, for each reason, a number of instances the model was not used to control communications with the network node.

### (Supplementary Note 110)

The method according to any one of supplementary notes 94 to 105, wherein the model is a classification model and wherein the metric comprises a confusion matrix of the model.

### (Supplementary Note 111)

The method according to supplementary note 110, wherein the report comprises the confusion matrix or parameters derived from the confusion matrix.

### (Supplementary Note 112)

The method according to any one of supplementary notes 94 to 105, wherein the model is configured to predict measurement of N best objects and wherein the metric comprises an indication of a number of instances a best object predicted by the model is within M best objects observed by the UE.

### (Supplementary Note 113)

The method according to any one of supplementary notes 94 to 105, wherein the model is configured to predict measurement of N best objects and wherein the metric comprises an indication of a number of instances a best object measured by the UE is within the N best objects predicted by the model.

### (Supplementary Note 114)

The method according to any one of supplementary notes 94 to 105, wherein the model is configured to predict a value of a parameter and wherein the metric comprises an indication of a number of instances the predicted value of the parameter is within a threshold range of a measurement of that parameter.

### (Supplementary Note 115)

The method according to any one of supplementary notes 94 to 105, wherein the model is configured to predict a value of a parameter and wherein the metric comprises an indication of a number of instances a measured value of the parameter is within a threshold range of a predicted value of the parameter from the model.

### (Supplementary Note 116)

The method according to any one of supplementary notes 72 to 115, wherein in a case of low latency reporting, the report is received via an Uplink Control Information UCI message.

### (Supplementary Note 117)

The method according to any one of supplementary notes 72 to 115, wherein in a case of low latency reporting, the report is performed via a Medium Access Control, MAC, Control Element, CE.

### (Supplementary Note 118)

The method according to supplementary note 117, wherein the MAC CE includes a Logical Chanel Identifier, LCID that indicates that the message comprises a model report.

### (Supplementary Note 119)

The method according to supplementary note 118, wherein the reporting is for multiple models and wherein an LCID value is provided for each model or a single LCID value is used for the multiple models.

### (Supplementary Note 120)

The method according to any one of supplementary notes 72 to 115, wherein depending on the amount of data in the report, a part of the data is received in an Uplink Control Information UCI message or in a Medium Access Control, MAC, Control Element, CE message and a part of the data is received in a Radio Resource Control, RRC, message.

### (Supplementary Note 121)

The method according to any one of supplementary notes 72 to 115, wherein in a case where an amount of data in the report is less than a threshold, the report is received in an Uplink Control Information UCI message or in a Medium Access Control, MAC, Control Element, CE message and otherwise the report is received in a Radio Resource Control, RRC, message.

### (Supplementary Note 122)

The method according to any one of supplementary notes 72 to 121, wherein the report is performed via an Uplink Control Information UCI message, a Medium Access Control, MAC, Control Element, CE message or a Radio Resource Control, RRC, message depending on a type of report that is reported.

### (Supplementary Note 123)

The method according to any one of supplementary notes 72 to 122, wherein the report includes measurements relating to a source cell and measurements relating to a target cell.

### (Supplementary Note 124)

The method according to any one of supplementary notes 72 to 122, wherein in a case where the UE switches a model, the report includes measurements for the model before the switch and measurements for the model after the switch.

### (Supplementary Note 125)

A user equipment, UE, comprising:
means for transmitting UE capability information to a network node;
wherein the UE capability information indicates which reporting quantities or metrics the UE can support for model performance reporting.

### (Supplementary Note 126)

A user equipment, UE, comprising:
means for receiving from a network node, a first indication for a model management decision and a second indication for model performance reporting; and
means for running the model and reporting model performance to the network node without using an output from the model to control communications with the network node, in a case where the first indication does not indicate activation of the model and the second indication enables model performance reporting.

### (Supplementary Note 127)

A user equipment, UE, comprising:
means for receiving from a network node configuration data for model performance reporting in respect of plural model functionalities;
means for running a model for each functionality configured by the configuration data; and
means for reporting model performance for each model functionality in accordance with the configuration data.

### (Supplementary Note 128)

A user equipment, UE, comprising:
means for running, at a first time, a model that predicts a parameter relating to a communication with a network node;
means for obtaining at least one measurement of at least one signal that relates to the parameter that is predicted by the model and that is received by the user equipment around the first time; and
means for reporting the parameter predicted by the model and the at least one measurement to the network node.

### (Supplementary Note 129)

A user equipment, UE, comprising:
means for running a model that predicts a parameter relating to a communication with a network node;
means for monitoring at least one metric related to the model or to the communication with the network node; and
means for reporting to the network node in a case where the at least one metric meets at least one criterion.

### (Supplementary Note 130)

A network node comprising:
means for receiving from a user equipment, UE, UE capability information;
wherein the UE capability information indicates which reporting quantities or metrics the UE can support for model performance reporting.

### (Supplementary Note 131)

A network node comprising:
means for transmitting to a user equipment, UE, a first indication for a model management decision and a second indication for model performance reporting;
means for receiving a report from the UE of model performance in respect of a model that is run on the UE without using an output from the model to control communications with the network node, in a case where the first indication does not indicate activation of the model and the second indication enables model performance reporting.

### (Supplementary Note 132)

A network node comprising:
means for transmitting to a user equipment, UE, configuration data for model performance reporting in respect of plural model functionalities; and
means for receiving model performance data from the UE in respect of running a model for each functionality configured by the configuration data for each model functionality in accordance with the configuration data.

### (Supplementary Note 133)

A network node comprising:
means for configuring a user equipment, UE, to run, at a first time, a model that predicts a parameter relating to a communication between the UE and the network node;
wherein the UE obtains at least one measurement of at least one signal that relates to the parameter that is predicted by the model and that is received by the user equipment around the first time; and
means for receiving a report from the UE including the parameter predicted by the model and the at least one measurement.

### (Supplementary Note 134)

A network node comprising:
means for configuring a user equipment, UE, to run a model that predicts a parameter relating to a communication with the network node;
wherein the UE monitors at least one metric related to the model or to the communication with the network node; and
means for receiving a report from the UE in a case where the at least one metric meets at least one criterion.

This application is based upon and claims the benefit of priority from Great Britain Patent Application No. 2305560.1, filed on Apr. 14, 2023, the disclosure of which is incorporated herein in its entirety by reference.

### REFERENCE SIGNS LIST

1 COMMUNICATION SYSTEM
3 USER EQUIPMENT
5 BASE STATION
7 CORE NETWORK
9 CELL
10 CONTROL PLANE FUNCTIONS
11 USER PLANE FUNCTIONS
20 EXTERNAL DATA NETWORK
41 DATA COLLECTION
43 MODEL TRAINING
47 MODEL MANEGEMENT
45 MODEL INFERENCE
49 MODEL STORAGE
310 TRANSCEIVER CIRCUIT
330 ANTENNA
350 USER INTERFACE
370 CONTROLLER
390 MEMORY
410 OPERATING SYSTEM
430 COMMUNICATIONS CONTROL MODULE
450 AI/ML MODULE
510 TRANSCEIVER CIRCUIT
530 ANTENNA
550 CORE NETWORK INTERFACE
570 CONTROLLER
590 MEMORY
610 OPERATING SYSTEM
630 COMMUNICATIONS CONTROL MODULE
650 AI/ML MODULE

What is claimed is:

1. A method performed by a mobile device, the method comprising:
managing at least one model for each functionality; and
transmitting, to a network node, performance information for each functionality or for each of the at least one model, and
wherein the performance information includes:
at least one prediction output related to a respective functionality or a respective model, and
ground truth information of measurements for determining, by the network node, whether the at least one prediction output is correct.

2.-15. (canceled)

16. The method according to claim 1, wherein
the managing the at least one model is performed based on that at least one metric meets at least one criteria,
the at least one prediction output includes measurement of N best objects, and
the at least one metric includes at least one of:
a number of times or a percentage that a best object predicted by the at least one model is included in M best objects measured by the mobile device, or
a number of times or a percentage that a best object measured by the mobile device is included in the N best objects predicted by the at least one model.

17.-32. (canceled)

33. The method according to claim 1, further comprising:
transmitting, to the network node, capability information indicating which quantities or metrics the mobile device can support for transmitting the performance information, for each of the functionalities or for each of the at least one model.

34. The method according to claim 33, wherein
the capability information indicates how frequently the mobile device can perform measurement for transmitting the performance information, for each of the functionalities or for each of the at least one model.

35. The method according to claim 33, further comprising:
receiving, from the network node, configuration information to perform the transmitting the performance information, and wherein
the transmitting is performed in response to receiving the configuration information.

36. The method according to claim 33, wherein
the capability information indicates an ability of the mobile device to run simultaneously a plurality of models for the same functionality.

37. The method according to claim 1, further comprising:
receiving, from the network node, configuration information for the transmitting the performance information for each functionality or for each model, and wherein
the managing the at least one model is performed by the configuration information, and
the transmitting the performance information is performed by the configuration information.

38. The method according to claim 37, wherein
the configuration information includes a respective functionality identifier for each functionality for which the transmitting the performance information is required.

39. The method according to claim 38, wherein
the configuration information indicates which one of the at least one model or configuration of the at least one model associated with the at least one model is to be run and for which the transmitting the performance information is to be performed.

40. The method according to claim 37, wherein
the configuration information includes at least one of:
a model identifier identifies which one of the at least one model or configuration of the at least one model associated with the at least one model is to be run and for which the transmitting the performance information is to be performed,
model configuration information for the at least one model, configuring a respective model that is to be run and for which the transmitting the performance information is to be performed, or
radio bearer configuration information for configuring a radio bearer between the mobile device and the network node that is used for the transmitting the performance information.

41. The method according to claim 1, wherein
the managing the at least one model is performed by running the at least one model to predict the at least one prediction output, and the method comprises:
performing at least one measurement in at least one measurement occasion for determining accuracy of the at least one prediction output.

42. The method according to claim 41, wherein
the at least one measurement occasion is defined by at least one of:
a periodicity and/or occasions configured by the network node,
a periodicity and/or occasions stored in the mobile device,
a capability of the mobile device,
a periodicity of signals used for the at least one measurement, or
a periodicity of the transmitting the performance information.

43. The method according to claim 41, wherein
the at least one measurement within a specific duration is only used for determining the accuracy of the at least one prediction output.

44. The method according to claim 43, wherein
the specific duration is defined by at least one of:
a timing of inferring the at least one prediction output,
a threshold value configured by the network node,
a threshold value stored in the mobile device UE, or
the at least one measurement occasion,

45. The method according to claim 44, wherein
at least one of the specific duration or the threshold is defined for each functionality of the at least one model or for each of the at least one model.

46. The method according to claim 1, wherein
the transmitting the performance information is performed based on at least one of:
an occasion for the transmitting the performance information,
a periodicity specific for the transmitting the performance information,
a trigger that when met, causes the mobile device to perform the transmitting the performance information, or
a request from the network node.

47. The method according to claim 46, wherein
the trigger defines a metric for prediction on the running the at least one model, and
the transmitting the performance information is performed based on a comparison between the metric and a threshold.

48.-49. (canceled)

50. A method performed by a network node, the method comprising:
receiving, from a mobile device, performance information for each functionality or for each of at least one model for each functionality, the at least one model being managed by the mobile device, and
wherein the performance information includes:
at least one prediction output related to a respective functionality or a respective model, and
information for determining, by the network node, whether the at least one prediction output is correct.

51. A mobile device comprising:
at least one memory storing instructions; and
at least one processor configured to execute the instructions to:
manage at least one model for each functionality; and
transmit, to a network node, performance information for each functionality or for each of the at least one model, and
wherein the performance information includes:
at least one prediction output related to a respective functionality or a respective model, and
information for determining, by the network node, whether the at least one prediction output is correct.

52. (canceled)
